(19) United States
(12) Patent Application Publication
(10) Pub. No.: US 2004/0150982 A1
(43) Pub. Date: Aug. 5, 2004

(54) Glow brick

(76) Inventor: Donald J.E. Miller JR., Tampa, FL (US)

Correspondence Address: Donald J.E. Miller, Jr., 6509 Secrest Ct., Tampa, FL, 33625, US

(21) Appl. No.: 10/357,575

(22) Filed: Feb. 4, 2003

(51) Int. Cl. F21L 4/00; F21K 2/00

(52) U.S. Cl. 362/34; 362/190; 362/191

(57) ABSTRACT

Glow Brick is a chemical light that when bent causes a class vile inside to brake and allows the chemical in the vile and the chemical in the body to mix, causing the glow brick to light. At the bottom of the glow brick is a strip of plastic with a hole on one side and a hook located across from it. The glow brick also incorporates a pocket clip, for a wider array of use.

### FIELD OF THE INVENTION

The Glow Brick relates to chemical lighted items, Shaped like a brick with a pocket clip on it, and having the hook and hole on the bottom flap located across from one another.

### BACKGROUND OF THE INVENTION

Chemical sticks today come with a round or octanguler body shape, and the bottom having a thin strip of plastic with a hole on the top part and a hook under it. The Glow Brick is rectangle shaped like a brick, and has the hole and hook located across from each other, plus there is a pocket clip for convinance.

### SUMMARY OF THE INVENTION

The glow brick is a chemical light that glows up when it's bent and the chemicals inside mix together. The glow brick can be used when there is no electricity, or in emergencies or various activities such as camping or exploring. The bottom of the glow brick has a hole in it to put a string through so it can be tide to an object or hung around the neck. It also has a hook next to the hole for hanging on a line, pocket or key ring. There is a pocket clip so the glow brick can be clipped onto the belt or a pocket, or even a vest like those used in scuba diving and the military. The glow brick is ideal when reading a map or changing a tire at night, and the glow brick light will last up to 12 hours.

### DESCRIPTION OF DRAWINGS

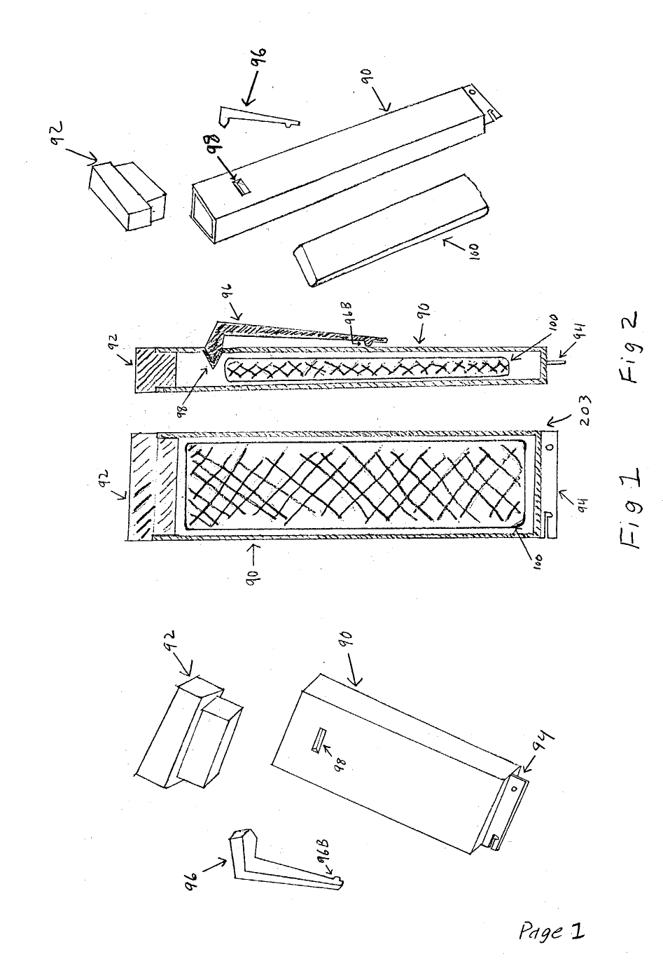

Page 1. Is the chemical glow brick, shown at different angels. Also pictured is the lid of the brick, the pocket clip and the inside glass tubing, plus a view of the completed light brick cut in half, from the front and side marked as FIG. 1 and 2.

It is to be understood that the present invention is not limited to the details of construction and arrangement of parts illustrated in the accompanying drawing(s), since the invention is capable of other embodiments, and is capable of being practiced or carried out in various ways within the scope of the claims. Also, it is to be understood, that the phraseology and terminology employed herein is for the purpose of description, and not of limitation.

### DESCRIPTION OF INVENTION

Page 1 shows a perspective of the Glow Brick, a chemical light. The body is a long rectangular plastic tube 90, with the depth of the tube being a little wider at the top than the bottom. FIGS. 1 & 2 shows the completed glow brick cut in half at the front and side. The glow brick has a plastic strip located at the bottom center and extends the width of the brick 94, and on one end of the strip is a hole to put a string through, and at the other end is a slip hook so the glow brick can be hung up if needed. The glow brick lid is one piece of plastic being a square rectangle shape 92, with the top half being wider and longer than the bottom half. At the back of the glow brick, located at the top center is a rectangular slot cut triangled into the brick 98. The pocket clip 96 is a small strip of plastic, bent at the top and has a grip notch at the bottom 96b. The top end of the pocket clip is triangle shaped, and sits in the triangle slot on the light brick body 98 and secured by glue or other adhesive. The vile 100, which is a rectangular glass tube that holds the first chemical, is placed inside the light brick body and the second chemical is then pored in with the vile. The lid of the glow brick 92 is then placed in the top opening of the brick and firmly pressed shut and sealed with glue or something similar.

1. A chemical light, consisting of a rectangular square tube body.

2. A chemical light according to claim 1, wherein said a pocket clip is incorporated for convenience.
